(19) United States
(12) Patent Application Publication
(10) Pub. No.: US 2015/0235234 A1
(43) Pub. Date: Aug. 20, 2015

(54) DEVICE FOR AUTHENTICATING A BOTTLE AND AUTHENTICATION METHOD USING SAID DEVICE

(71) Applicant: WABASH, Bordeaux (FR)

(72) Inventor: Tanguy Hoegh-Guldberg, Bordeaux (FR)

(21) Appl. No.: 14/425,770

(22) PCT Filed: Sep. 4, 2013
(86) PCT No.: PCT/FR2013/052033

§ 371 Date: Mar. 4, 2015

(30) Foreign Application Priority Data
Sep. 5, 2012 (FR) 12 58297
Sep. 5, 2012 (FR) 12 58298

(51) Int. Cl. G06Q 30/00; G06K 7/10

(52) U.S. Cl. CPC G06Q 30/0185; G06K 7/10415

(57) ABSTRACT

A device for authenticating a bottle, which includes a neck (16) having a foil capsule (20) defined by a lower edge (24), and a marker (12) having an electronic component (34) and an antenna (36) enabling communication with an apparatus, the electronic component (34) and the antenna (36) occupying an area A which corresponds to at least one portion of the surface of the marker (12), characterized in that the marker (12) is arranged to overlap the lower edge (24) and in that at least 25% of the area A covers the portion of the bottle located under the lower edge (24) of the foil capsule (20) in order to limit the disruptions induced by the foil capsule (20) on the antenna (36).

This invention relates to a device for authenticating a bottle as well as to an authentication method using said device.

In a known way, a wine bottle has in the area of its neck a cork inserted into the neck and an overcap that covers the open portion of the neck and the cylindrical upper end of the neck. This overcap is generally made of metal.

The bottle comprises in the area of its body a label that makes it possible to identify the contents of the bottle and optionally a label on the reverse on which additional information appears.

The label comprises information required by law as well as information making it possible to identify the contents of the bottle such as for example a trademark.

A first level of counterfeiting consists in marketing any kind of wine with a fake content and bogus labels on which information appears that is similar to the authentic labels. This level of counterfeiting can be easily thwarted by an informed consumer. Furthermore, to help the consumer detect the counterfeiting, there are computer applications that make it possible from a “smartphone” type telephone to photograph the label and compare it with authentic labels listed in a database that can be accessed via a telephone or computer network such as the Internet.

At this first level, the fight against counterfeiting essentially requires raising the awareness and training of consumers in the wine world. For this purpose, certain applications offer, in addition to the authentication, additional information about the wine contained in the authenticated bottle, making it possible to educate the consumer.

A second level of counterfeiting, more sophisticated than the first, consists in marketing any kind of wine with fake contents and labels identical to the authentic labels. In this case, even an informed consumer can be misled. To address this level of counterfeiting, several solutions have been developed. By way of example, a first solution consists in using a bubble code on the label or a two-dimensional barcode, also known as “QR code”, that is associated with a hologram that is also affixed to the label.

By way of example, the document WO2010/063909 describes a label with several visual security elements. Thus, this document does not describe any electronic-type system for authentication whose functioning can be altered by a metallic or metallized overcap.

As before, applications have been developed that make it possible, from a “smartphone”-type telephone, to photograph this display code (bubble codes or QR code) and compare it with those appearing in a data base to determine whether the bottle is authentic.

However, these solutions are not completely satisfactory because the techniques of the counterfeiters are becoming increasingly sophisticated and make it possible, from an authentic visual code, to reproduce it by photocopying it and affixing visual codes that are identical to the authentic visual codes on labels intended for counterfeiting.

Even though the bubble code is more difficult to reproduce, its cost is relatively high because it is not widely used. Furthermore, there are very few users who know intuitively how to use it. In the case of the bubble code, for example, this device with a complex appearance is difficult to reproduce. However, it needs to be reproduced only if the user seeks to authenticate it with a very specific and very hard-to-find scanner. Now, in reality, authentication is achieved in 99% of the cases by a simple visual comparison by scanning a QR code leading directly to a data base that references all the bubble codes. Thus, the user will be misled by a simple photo taken by modest means since he will rely only on a 2D scan that is similar to the scanning of a QR code or of a “Datamatrix”-type code.

In the field of the traceability of bottles of wine, markers containing an electronic chip, also called an RFID chip, can be affixed to boxes of bottles or to the bottles. These markers also contain a temperature sensor and optionally a geo-locating sensor, making it possible to measure at regular intervals the temperature of the environment, with the measurements being stored in the RFID chip. In a known way, an RFID chip comprises a microprocessor associated with an antenna that makes it possible to exchange signals.

According to this solution, the RFID chip makes it possible to ensure that the bottle or the box has been kept in suitable conditions over the entire distribution route.

This solution could be repurposed and used to authenticate a bottle because each RFID chip comprises a unique identifier.

The advantages provided by the RFID chip are the following:

Because this technology is widely used, the costs of the labels containing an RFID chip are steadily dropping.

Because of international standards, each RFID chip has a unique identifier. Thus, two RFID chips cannot have the same identifier.

According to another advantage, for now it is difficult to duplicate an RFID chip and to use in its place an identifier corresponding to that of another RFID chip.

RFID chips can be passive and not require the use of a battery. Consequently, the life of such a chip is almost unlimited.

Finally, a wireless communication standard (called near field communication or NFC communication) makes it possible to have these RFID chips communicate with a very large number of devices. Thus, the majority of mobile telephones are sold with this technology and can therefore communicate with RFID chips.

This solution could address the authentication objectives by making copying difficult and facilitates authentication thanks to applications installed on a communicating device such as a “smartphone”-type telephone which, while interfacing on the one hand with the RFID chip, can read its identifier and, by interfacing on the other hand with a server, compare it with those in a data base to authenticate the bottle.

Finally, a last level of counterfeiting consists in marketing any kind of wine in an authentic bottle. Considering the rising costs of certain bottles, networks that are designed to collect authentic bottles when the contents of the latter have been drunk are developing. After being recovered, these bottles are refilled, recorked and resold with generally a poor wine. This type of counterfeiting is aimed at the high-end market and primarily affects the Asian markets whose consumers generally have a low level of knowledge with regard to wine. This counterfeiting causes significant harm both economically and in terms of image because, not being great connoisseurs, the consumers may think, wrongly, that the poor wine corresponds to the authentic wine. In some cases, the bottle can be refilled with a liquid that is unfit for consumption, which can undermine food safety and therefore threaten the health of the consumer.

To combat this type of counterfeiting, solutions propose placing the marker containing the RFID chip in the area of the overcap in such a way that opening of the bottle irreversibly alters the functioning of the RFID chip.

In the case of a bottle of liquor, the overcap comprises a perforation line that makes it possible upon opening to separate the upper part of the overcap so as to be able to withdraw the cork. In this case, the RFID marker straddles the perforation line. Thus, upon opening, the RFID chip and more particularly its antenna are irreparably damaged when the perforation line is cut and the upper part of the overcap is removed.

In the case of a bottle of wine, the marker containing the RFID chip comes in the form of a strip affixed along a generatrix of the neck of the bottle from the glass of the bottle to the top of the neck of the bottle. Thus, upon opening of the bottle, since the upper part of the overcap is removed to be able to extract the cork, the RFID chip and more particularly its antenna are irreparably damaged. This type of placement is described in particular in the document U.S. Pat. No. 6,360,208.

In both cases, since the RFID chip is irreparably damaged after the first opening of the bottle, the authentic bottle that would possibly be refilled could no longer be reauthenticated.

This method of placing the marker containing the RFID chip makes it possible in theory to be able to address effectively all the levels of counterfeiting.

In practice, this method of authentication is not completely satisfactory for the following reason:

Since the overcap is made of metal, it interferes with the proper operation of the RFID chips because the latter operate on the basis of electromagnetic fields. Also, it can happen that the RFID chip is not able to communicate and allow the authentication of the bottle. In this case, the user might wrongly believe that he is dealing with a counterfeit product. To prevent this malfunction, solutions described for example in the document EP-1,857,374 propose insulating the RFID chip from the overcap. However, these solutions are not satisfactory because it is necessary to create specific markers or to use more complex techniques for placing the marker to insulate it, which impact the cost of the authentication method.

This invention aims to eliminate the drawbacks of the prior art.

In a non-exhaustive manner, one objective of the invention is to ensure the authentication of a bottle reliably at no additional cost even when the bottle has a metal overcap.

To achieve this objective, the invention proposes a device for authenticating a bottle that comprises on the one hand a neck with an overcap delimited by a lower edge and on the other hand a marker with an electronic component and an antenna that make it possible to communicate with a device, with said electronic component and said antenna occupying a zone A which corresponds to at least a portion of the surface area of the marker, characterized in that the marker straddles the lower edge and wherein at least 25% of the zone A covers the part of the bottle located under the lower edge of said overcap to limit the disturbances caused by the overcap on the antenna.

Advantageously, the marker comprises in the area of its outer face a coating that forms a sealed barrier. This solution makes it possible to improve the strength of the marker.

The invention also proposes an authentication method that makes it possible to increase the level of security.

Other characteristics and advantages will become evident from the following description of the invention, a description that is given by way of example only, with reference to the accompanying drawings in which:

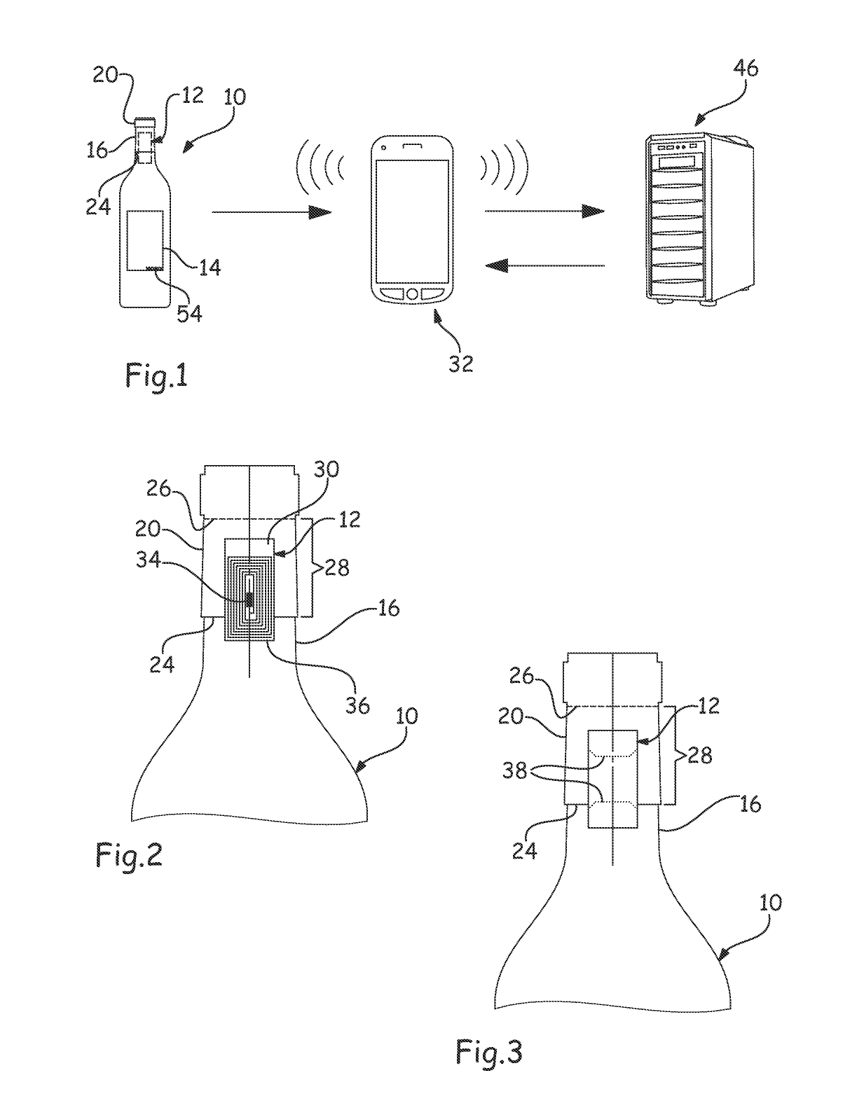

FIG. 1 is a diagrammatic representation of the device for authenticating a bottle according to the invention,

FIG. 2 is a front view of a neck of a bottle on which a marker according to the invention is affixed, illustrating by transparency an RFID chip,

FIG. 3 is a front view of a neck of a bottle on which a marker according to a variant of the invention is affixed,

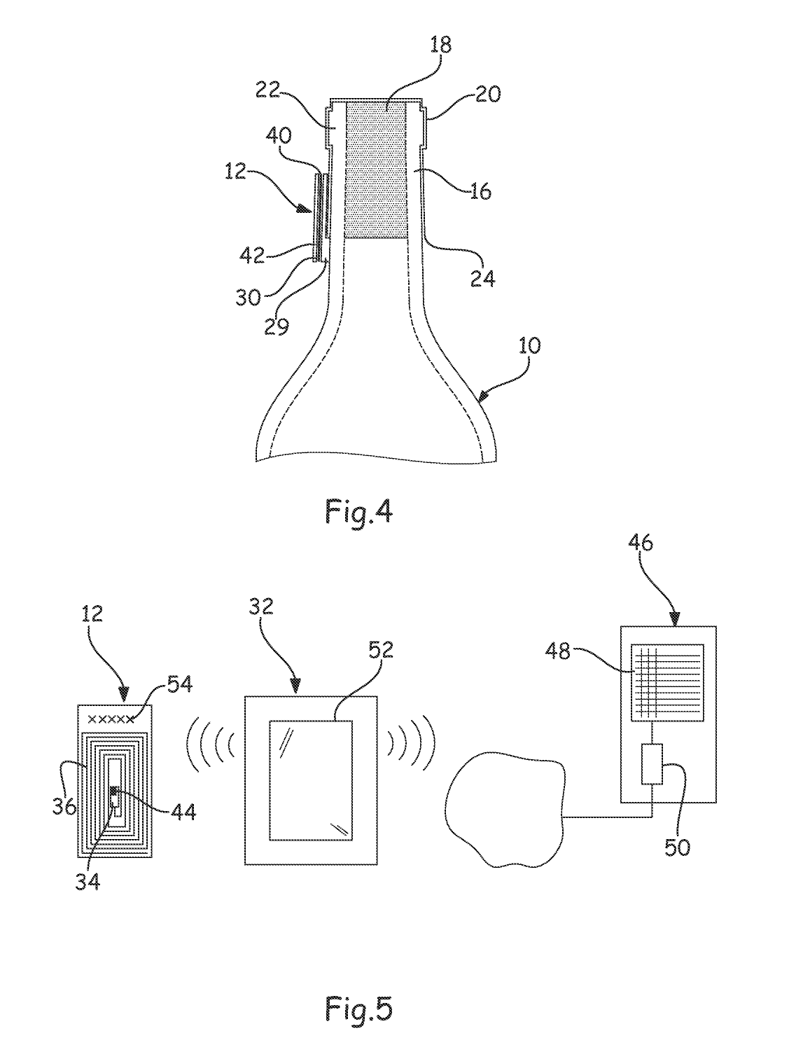

FIG. 4 is a section of a neck of a bottle on which a marker according to another variant of the invention is affixed,

FIG. 5 is a diagram illustrating an authentication method according to the invention,

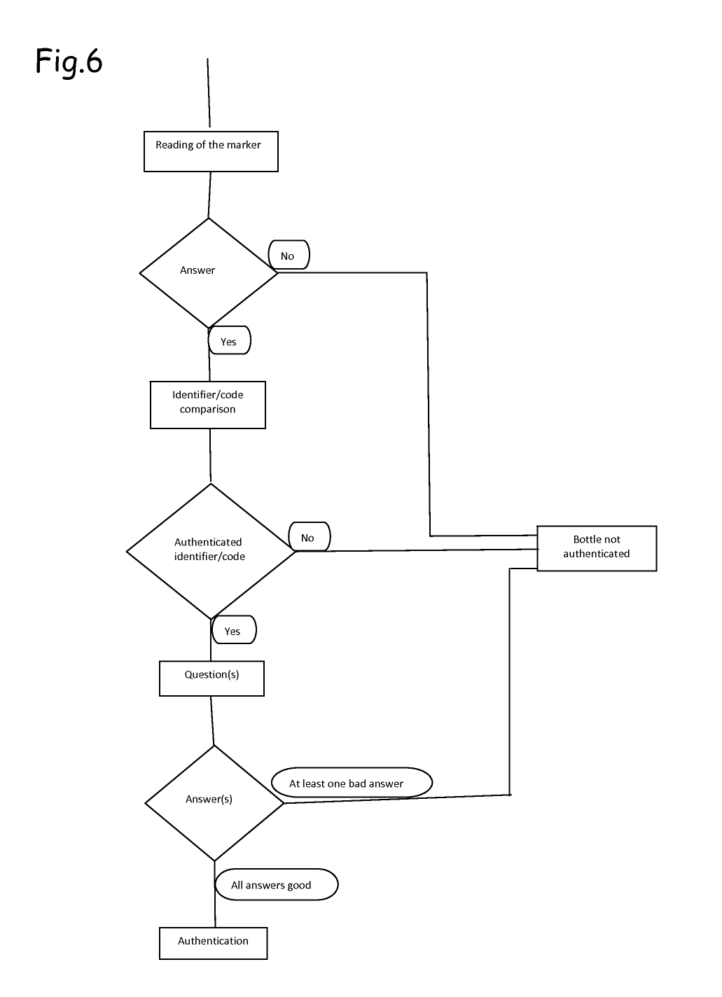

FIG. 6 is a diagram illustrating the implementation of an authentication method according to a first variant of the invention,

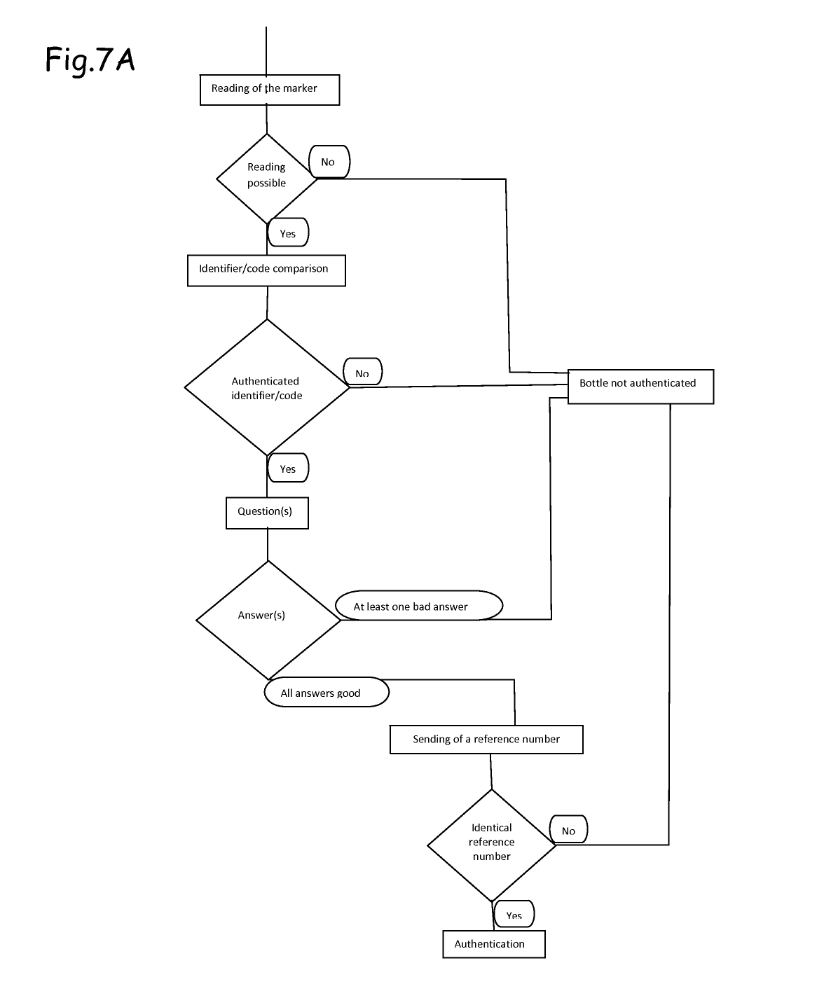

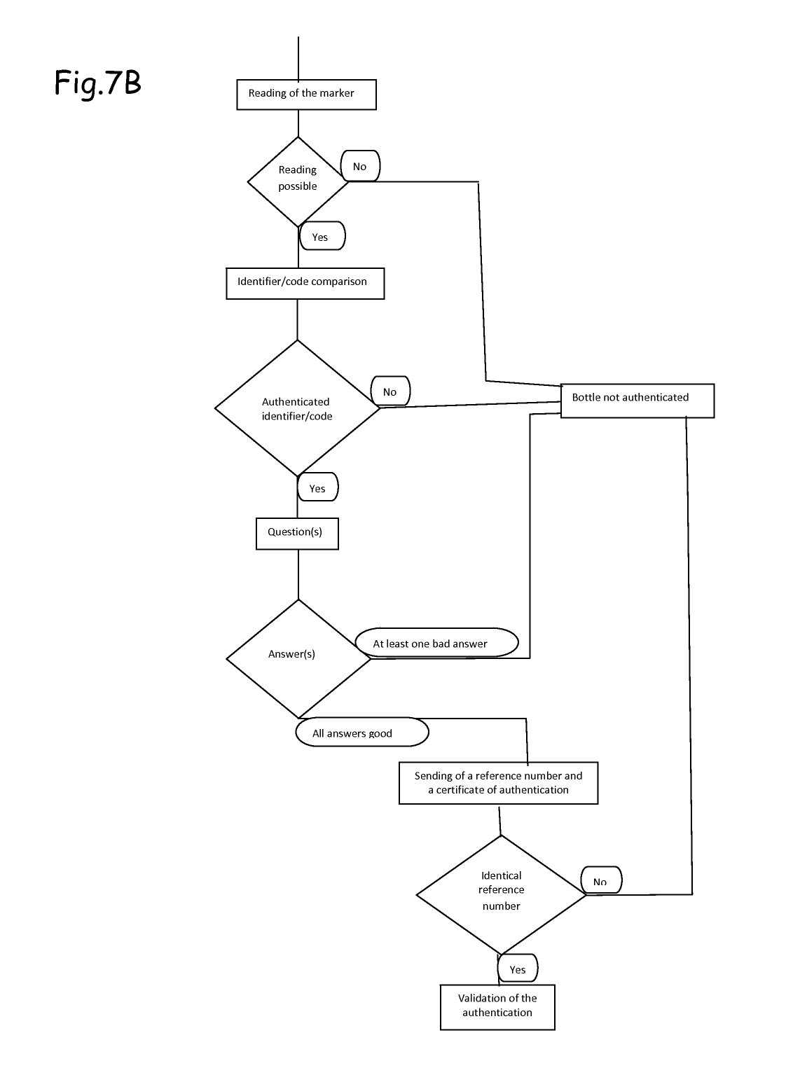

FIG. 7A is a diagram illustrating the implementation of an authentication method according to a second variant of the invention, and

FIG. 7B is a diagram illustrating the implementation of an authentication method according to a third variant of the invention.

In FIG. 1, a bottle has been represented by 10 comprising a marker 12 according to the invention that makes it possible to authenticate said bottle.

In a known way, the bottle 10 comprises on the one hand a body on which a label 14, and optionally a label on the reverse, is affixed, and on the other hand a neck 16 above the body into which a cork 18 (visible in FIG. 4) is inserted, covered with an overcap 20.

Legal information and information making it possible to identify the bottle (such as a trademark) appear on the label 14.

The neck 16 generally comprises a rim 22 that projects relative to the outer surface of the neck and is offset in relation to the upper end of the neck.

The overcap 20 is generally made of metal (tin or aluminum) and comprises a skirt that extends from the upper end of the neck over a certain height, on the order of 5 to 6 cm. Thus, the lower edge 24 of the overcap is offset downward in relation to the rim 22 by a distance on the order of 3 to 4 cm. These dimensions are given by way of example and are in no way limiting.

During the opening of the bottle, the overcap 20 is cut using a slicing tool along a perforation line 26 that is located just under the rim 22. Following this cutting, the upper part of the overcap 20 is removed to make it possible to extract the cork. The lower part 28 of the overcap 20 in the form of a sleeve remains on the bottle.

All the elements previously described are known to one skilled in the art and are not further detailed. The techniques for filling bottles, for corking and for placing labels and overcaps have been fully mastered and are generally automated. They are not further described.

To allow its authentication, a bottle comprises a marker 12. This marker comes in the form of a label straddling the glass of the bottle and the overcap 20, on both sides of the lower edge 24 of said cap. To provide an order of magnitude, the marker 12 is a square 30 mm on a side. Nevertheless, the marker is not limited to this geometry and can have variable dimensions and shapes (square, rectangular, round, . . . ).

This marker 12 is affixed on the bottle 10 by gluing. Advantageously, in the area of one of its faces the marker 12 comprises an adhesive coating 29 that makes it possible for it to be attached by sticking on the bottle, as illustrated in FIG. 4. This adhesive coating or this glue has excellent bonding strength so as to limit the risks of the marker 12 being peeled off.

According to an embodiment, the marker 12 comprises a film 30 in the format of the marker to which are connected means for storing a piece of information and means for contactless communication making it possible to exchange information with a scanner 32.

To reduce manufacturing costs, the information storage means and the communication means are incorporated into an RFID chip. This solution makes it possible to reduce the costs of the marker provided that the RFID chips are manufactured in large numbers.

However, the invention is not limited to an RFID chip. It thus covers all electronic devices that make it possible to store at least one piece of information and to communicate with another device in accordance with a contactless communication protocol. Thus the marker can incorporate an NFC-type chip, and more particularly a chip of the “NFC inlay” type. As illustrated in FIG. 2, the marker 12 comprises an electronic device with at least one electronic component 34 with at least one memory device, more particularly a microprocessor, and at least one antenna 36. Depending on the variants, the electronic device can be passive or be semi-passive and incorporate a sensor such as a temperature sensor, for example.

According to a preferred embodiment, the communication protocol is of the near field communication type of the NFC type defined according to the standards recognized by the NFC Forum including the standards ISO/CEI 14443-1 to ISO/CEI 14443-4.

Since the majority of mobile telephones and touch tablets are equipped with the NFC technology, they can be used as scanner 32. Thus, all the owners of such devices can use them to authenticate a bottle according to the invention. This solution has the advantage of using widely accessible devices as scanners, which makes it possible to reduce the costs of authentication and to democratize the authentication method very quickly.

This technology is widely used because it is also employed for contactless payment and its usage is very intuitive.

In the area of the marker 12, the electronic component 34 and the antenna 36 occupy a zone A which corresponds to at least a portion of the surface area of the marker 12. According to an important characteristic of the invention, at least 25% of the zone A occupied by the electronic component 34 and the antenna 36 does not cover the overcap 20 and covers the part of the bottle located under the lower edge 24 of said cap that is not covered by the overcap.

This solution makes it possible to limit the disturbances caused by the metal overcap 20 on the marker and significantly increases the reliability of the authentication. Furthermore, this solution makes it possible to use widely marketed RFID chips without adding insulation means that can increase costs considerably.

The placing of the marker 12 on the bottle can be done during bottling by using a machine to deposit the labels.

The portion of the zone A located under the lower edge 24 of the overcap represents less than 90% of the total surface area of the zone A. This solution makes it possible to be sure that the marker is irreparably damaged and will no longer function during the removal of the cap since this removal is required when the bottle is reused so as to replace it with a new overcap.

According to another characteristic of the invention, the zone A does not cover the rim 22 and does not extend above the perforation line 26 that is located just under the rim 22.

This solution makes it possible to avoid altering the functioning of the marker 12 when the bottle is opened. When the consumer opens the bottle as he must, the lower part of the overcap 20 is kept on the bottle and the marker 12 is not damaged. Thus, it is possible to authenticate the bottle and to obtain additional information even after the bottle is opened, in contrast to the prior art.

Thus, according to the invention, the marker is irreparably damaged and no longer functions not when the bottle is opened, but rather at the time when an attempt is made to counterfeit and reuse the bottle since it is necessary to remove the rest of the overcap during the repackaging of the bottle.

Advantageously, the marker 12 comes in the form of a label with at least one perforation 38 (visible in FIG. 3) so that the marker 12 tears apart during an attempt to take it off. In the case of an “NFC inlay”-type marker, the latter is positioned and treated specifically so that it is destroyed permanently during any attempt to peel it off.

According to another characteristic, the marker 12 comprises in the area of its outer face 40 a coating 42 which forms a sealed barrier, making it possible to enhance the moisture resistance of the marker. This solution makes it possible to increase the reliability of the marker by protecting the electronic component 34 and the antenna 36. According to one embodiment, the coating 42 is made from a polymer, particularly from a printable polyethylene-based polymer.

A marker installed according to the recommendations of the invention makes it possible to ensure the authentication of a bottle reliably at no additional cost even when the bottle has a metal overcap.

The design of the marker incorporating an RFID chip, at least one perforation 38 and a coating 42 and using an NFC-type communication protocol makes it possible to achieve the following objectives:
To make it more difficult to transfer the marker used to authenticate the bottle,
To improve the strength of the marker, and
To simplify and democratize the method of authentication.

Along with an authentication device using a marker affixed in a specific manner to the bottle, the invention also proposes a method of authentication with a high level of security.

As illustrated in FIG. 5, the marker according to the invention comprises an electronic component 34 comprising at least one memory device 44 and an antenna 36 making it possible to communicate information with a communicating device 32.

Advantageously, as previously indicated, the marker 12 comes in the form of an RFID chip, and the device 32 incorporates the near field communication technology of the NFC type. According to the example illustrated, the device 32 is a mobile telephone of the “smartphone” type. Nevertheless, the invention is not limited to this type of device. Thus, a touch tablet or any device incorporating the NFC protocol will also do.

The whole of the authentication device comprises at least one server 46 with at least one data base 48 and one “server” application 50, with said server 46 being able to be connected via a telephone network or a computer network, particularly the Internet, to a communicating device 32.

The communicating device 32 comprises a roaming application 52 making it possible for it to communicate on the one hand with the marker 12 and on the other hand with the server 46 but also to provide an interface with the user.

According to an important point of the invention, the memory device 44 of the marker 12 comprises on the one hand an identifier that is unique to each memory device and that is assigned to the memory device 44 when it is manufactured, and on the other hand at least one code that is used in the memory device during its use. Advantageously, the marker 12 comprises a visual reference number 54, such as for example a serial number.

According to the standards, each RFID chip comprises an identifier that is unique to it and that is assigned during its manufacture.

The code is implemented in the memory device 44 prior to the placing of the marker 12. Thus, each marker 12 comprises a code that is unique to it.

In the data base 48, associated with each bottle 10 are the identifier of the memory device 44 of the marker that is affixed to said bottle and a code corresponding to the code implemented in said memory device 44. The code implemented in said memory device 44 varies from one marker to the next. Consequently, each code is unique.

Preferably, the code present in the memory device is encrypted. Concurrently, the data base associates with each bottle the identifier of the marker and a decrypted code that corresponds to the encrypted code used in the memory. The encryption means are not further detailed because they are known.

The presence of the encrypted code makes it possible to increase significantly the degree of security, provided that, unlike the identifier, it is not determined by the manufacturer of the RFID chips but rather by the company managing the authentication method according to the invention.

Hereinafter, the variants described with an encrypted code also function with a non-encrypted code.

According to the invention, associated with each bottle 10 are at least one question relating to a characteristic of the bottle 10 and its answer. Preferably, this characteristic is visual and relates to at least one physical feature of the contents, for example to a detail appearing on the overcap 20, on the label 14 and/or on the bottom of the bottle.

The association of at least one question/answer pair with the identifier and with the code used in the memory device 44 makes it possible to increase the level of security by increasing the number of combinations, knowing that these question/answer pairs vary from one wine to the next. These question/answer pairs are generally determined by the wine maker and are therefore different from one producer to the next. Moreover, it informs and reassures the user because he participates in the authentication.

By way of example, the question can consist in showing an image of a label and asking the user whether this image corresponds to the label appearing on the bottle that the user is seeking to authenticate.

Preferably, to complicate counterfeiting and increase the level of security, associated with each bottle are several question/answer pairs. According to one procedure, associated with each bottle are three question/answer pairs, a first question relating to a visual characteristic of the neck, a second question relating to a visual characteristic of the label, and a third question relating to a visual characteristic of the bottom of the bottle. However, the invention is not limited to this series of question/answer pairs.

For each bottle the data base associates an identifier, an encrypted code, at least one question/answer pair relating to a characteristic of the bottle and a certificate of authentication.

Advantageously, for each bottle the data base associates an identifier, an encrypted code, at least one question/answer pair relating to a characteristic of the bottle, a string of alphanumeric characters that corresponds to the visual reference number 54 and a certificate of authentication. Thus, the visual reference number 54 makes it possible for the user to refer to a unique visible security feature to demonstrate the presence of the non-visible safety features (identifier and code used in the memory device 44 of the marker).

The roaming application 52 of the communicating device 32 performs several functions. In the first place, the roaming application comprises a marker-reading module 12 that makes it possible to read the identifier and the encrypted code implemented by the memory device 44 of the marker.

The roaming application also comprises a communication module that makes it possible to exchange information between the communicating device 32 and the server 46. Thus, the communication module ensures the transmission of the identifier and of the encrypted code to the server 46 as well as the exchanges between the communicating device and the server relative to the question/answer pairs and to the certificate of authentication.

The roaming application also comprises an interface that makes it possible, for each question/answer pair, to display the question and to capture the user's answer and to display the certificate of authentication which incorporates the visual reference number 54, if the authentication is successful.

The roaming application can be downloaded via a telephone or computer network. Advantageously, to simplify the downloading of the roaming application, the memory device 44 of the marker comprises at least one URL-type address of a site from which the roaming application can be downloaded. Thus, by bringing the communicating device 32 near the marker 12, the identifier, the code and the URL address are read by the device 32. If the device does not yet have the roaming application, a message is displayed on its device inviting it to be directed to a site for downloading the application.

The “server” application comprises means for communication with a communicating device 32 that sends a request to it as well as means for processing the information, making it possible:
to compare the identifier/encrypted code pair with those present in the data base 48,
if the identifier/encrypted code pair is detected in the data base, to read the associated question/answer pair or pairs and to send it or them to the communicating device once the request is made,
if the answers provided by the user are correct, to send the certificate of authentication incorporating the visual reference number 54 that is associated with the identifier/encrypted code pair/answers to the questions.

As illustrated in FIG. 6, the method of authentication comprises an algorithm with the following steps:
Reading, by bringing the communicating device near the marker, of the identifier and of the encrypted code present in its memory device,
If the marker and more specifically its RFID chip have been damaged because of an act of counterfeiting, this reading cannot be made and the roaming application informs the user that the bottle cannot be authenticated,
If reading is possible, the communicating device sends to the server a request referring to the identifier/encrypted code pair,
After decrypting the code, the server compares this identifier/encrypted code pair with those present in the data base,
If this pair does not appear in the data base, the server sends a message to the communicating device that then indicates to the user that the bottle cannot be authenticated,
If this identifier/code pair is present in the data base, the server sends, to the communicating device that has made the request, at least one question/answer pair relating to a visual characteristic or characteristics of the bottle,
If at least one answer provided by the user is not correct, the roaming application indicates to the user that the bottle cannot be authenticated,
If all the answers are correct, the server sends the certificate of authentication to the communicating device that made the request which it displays,
Finally, on the basis of the certificate of authentication provided, the user can compare the unique visual reference number 54 present both on the marker 12 and on the certificate of authentication.

According to other variants illustrated in FIGS. 7A and 7B, for each bottle the data base associates an identifier, a decrypted code, at least one question/answer pair relating to a characteristic of the bottle, a string of alphanumeric characters that correspond to the visual reference number 54 and a certificate of authentication.

According to an embodiment, this visual reference number 54 comprises a string of alphanumeric characters.

This visual reference number 54 is present on an authentic bottle, particularly on the marker 12. Alternatively, it can be affixed on the label of the bottle as illustrated in FIG. 1.

According to a first procedure illustrated in FIG. 7A, if all the answers are correct, the server sends, to the communicating device that made the request, the visual reference number associated with the bottle, which displays it on the screen. If the user confirms the presence of this visual reference number on the bottle, the server 46 then sends the certificate of authentication.

According to another procedure illustrated in FIG. 7B, if all the answers are correct, the server sends, to the communicating device that made the request, the certificate of authentication which comprises the visual reference number 54. Thus, the user can compare the sent visual reference number 54 to the one affixed on the bottle to make a final verification.

This new question makes it possible to strengthen security and complicates any counterfeiting.

Advantageously, when the bottle is authenticated, the server 46 can send other information relating to the wine, the producers, the dealers, the consumers, etc. This functionality makes it possible, in addition to the authentication, to track the products, to educate the consumer, to promote the products and the trademarks and to exchange information.

Advantageously, when the bottle is not authenticated, the roaming application asks the user if he would like to report the counterfeit. In this case, the application invites him to take a photo of the bottle with his device 32, and the latter, accompanied by the geo-location coordinates of the device 32 (supplied by the geo-location system incorporated in the device), is sent to the server 46. This feedback makes it possible to locate the counterfeit and to step up the fight against it.

Although described as applying to bottles of wine, the authentication method can be used for other products, such as for example drugs or luxury goods.

In addition, the authentication method is more particularly intended to be used with the marker 12 according to the invention, affixed in a certain manner on the bottle. However, it could be used with other markers containing a memory device and using the near field communication protocol.

Finally, the communicating device 32 could incorporate the data base 48 and all the functionalities of the “server” application. In this case, according to a very simplified variant, the authentication device could comprise only one device communicating with the marker and would not include a server.

1. Device for authenticating a bottle that comprises on the one hand a neck (16) with an overcap (20) delimited by a lower edge (24) and on the other hand a marker (12) with an electronic component (34) and an antenna (36) making it possible to communicate with a device (32), where said electronic component (34) and said antenna (36) occupy a zone A which corresponds to at least a portion of the surface area of the marker (12), wherein the marker (12) straddles the lower edge (24) and at least 25% of the zone A covers the part of the bottle located under the lower edge (24) of said overcap (20) to limit the disturbances caused by the overcap (20) on the antenna (36).

2. Device for authenticating a bottle according to claim 1, wherein the portion of the zone A located under the lower edge (24) of the overcap represents less than 90% of the total surface area of the zone A.

3. Device for authenticating a bottle according to claim 1, wherein the zone A does not extend above a perforation line (26) of the overcap (20) that is cut to open the bottle.

4. Device for authenticating a bottle according to claim 1, wherein the marker (12) comes in the form of a label with at least one perforation (38) so that the marker (12) tears apart during any attempt to take it off.

5. Device for authenticating a bottle according to claim 1, wherein the marker (12) comprises in the area of its outer face (40) a coating (42) that forms a sealed barrier.

6. Device for authenticating a bottle according to claim 1, wherein the electronic component (34) and said antenna (36) are incorporated into an RFID chip.

7. Device for authenticating a bottle according to claim 1, wherein the electronic component (34) comprises a memory device (44) with an identifier that is assigned to the memory during its manufacture and at least one code that is programmed into the memory when it is in use.

8. Device for authenticating a bottle according to claim 7, wherein it comprises a communicating device (32) incorporating a roaming application that has a module for communication with the marker (12) to read the identifier and the code from the memory device (44) and a user interface.

9. Device for authenticating a bottle according to claim 8, wherein the memory device (44) comprises at least one URL-type address of a site from which the roaming application can be downloaded.

10. Device for authenticating a bottle according to claim 7, further comprising a server (46) comprising a data base (48) that associates, with each bottle, the identifier of the memory device (44) of the marker affixed on said bottle and a code corresponding to the code implemented in said memory device (44), and a “server” application having means for communicating with a communicating device (32) which sends a request to it as well as means for processing the information.

11. Authentication method for a product on which a device according to claim 1 is affixed.

12. Authentication method according to claim 11, with said method comprises comparing information contained in the memory device of the marker (12) with information contained in a data base (48), wherein the memory device (44) of the marker (12) comprises an identifier which is unique to each memory device and a code that is programmed into the memory device during its use, wherein the data base (48) associates, with each product, the identifier of the memory device (44) of the marker affixed to said product, a code corresponding to the code implemented in said memory device (44), at least one question/answer pair relating to a characteristic of the product (10) and a certificate of authentication, where the method comprises:
reading the identifier and the code of the memory device (44) of the marker (12) of the product that a user is seeking to identify,
comparing the identifier/code pair with those present in the data base (48),
if the identifier/code pair is detected in the data base, reading the associated question/answer pair or pairs,
if the answer(s) provided by the user are correct, sending the certificate of authentication associated with the identifier/code pair.

13. Authentication method according to claim 12, wherein the characteristic of the product is visual and is related to at least one physical feature of the product.

14. Authentication method according to claim 12, wherein the data base associates, with each product, multiple question/answer pairs.

15. Authentication method according to claim 12, wherein the data base associates, with each product, an identifier, a code, at least one question/answer pair relating to a characteristic of the product, a visual reference number (54) affixed to the product and a certificate of authentication.

16. Authentication method according to claim 15, wherein the visual reference number (54) comprises a string of alphanumeric characters.

17. Authentication method according to claim 12, wherein the memory device (44) is incorporated into an RFID chip which communicates with a device (32) which itself communicates with a server (46) containing the data base (48) and incorporates a roaming application.

18. Authentication method according to the claim 17, wherein the memory (44) device comprises at least one URL-type address of a site from which the roaming application can be downloaded.

19. Device for authenticating a bottle according to claim 2, wherein the zone A does not extend above a perforation line (26) of the overcap (20) that is cut to open the bottle.

20. Authentication method according to claim 13, wherein the data base associates, with each product, multiple question/answer pairs.
